(19) United States
(12) Patent Application Publication
(10) Pub. No.: US 2005/0063632 A1
(43) Pub. Date: Mar. 24, 2005

(54) Tunable dispersion compensation using a photoelastic medium

(76) Inventor: Achintya K. Bhowmik, San Jose, CA (US)

Correspondence Address: TROP PRUNER & HU, PC, 8554 KATY FREEWAY, SUITE 100, HOUSTON, TX, 77024, US

(21) Appl. No.: 10/669,938

(22) Filed: Sep. 24, 2003

(51) Int. Cl. G02F 1/295

(52) U.S. Cl. 385/8

(57) ABSTRACT

Dispersion in an optical medium may be compensated for by providing a dispersion of the opposite sign. The dispersion of the opposite sign may be tunably provided by stressing a photoelastic medium. In other words, a tunable degree of dispersion compensation can be applied by providing an adjustable amount of stress to a photoelastic medium, which in turn generates a dispersion which may be of an amount sufficient to compensate for the dispersion induced in the optical medium.

### BACKGROUND

This invention relates generally to compensating for dispersion in optical systems.

Optical systems, such as wavelength division multiplexed (WDM) optical communication networks, are subject to dispersion. Dispersion is due to the dependence of the velocity of light on the wavelength of light, as a light signal propagates through an optical medium. Dispersion ultimately results in pulse spreading, limiting the bandwidth of a common optical transport medium.

Currently, dispersion compensating fiber spools or fiber Bragg gratings are used to provide a fixed amount of dispersion with the required positive or negative sign. In other words, if the induced dispersion is positive, the dispersion compensating fiber may introduce a compensating negative dispersion.

However, the extent of dispersion that may be induced at any given instance, may be variable through the optical medium. It may vary as a function of temperature, wavelength, change in the communication link length, and other criteria. As a result, a fixed dispersion compensator is of relatively limited usefulness.

Thus, there is a need for better ways to provide dispersion compensation in optical systems.

### BRIEF DESCRIPTION OF THE DRAWINGS

FIG. 1 is a schematic depiction of one embodiment of the present invention; and

FIG. 2 shows the calculated dispersion induced by a photoelastic medium as a function of applied stress in accordance with one embodiment of the present invention.

### DETAILED DESCRIPTION

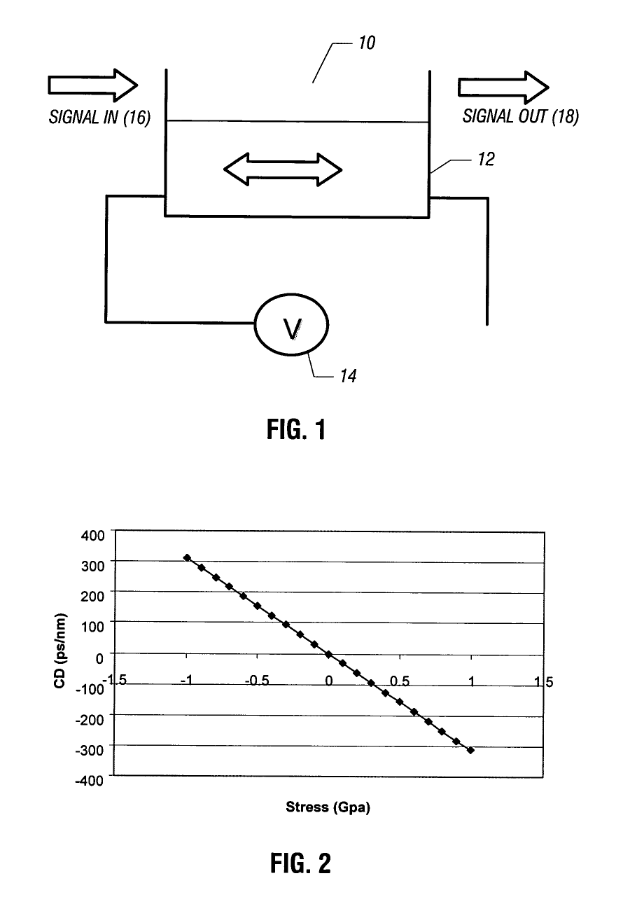

Referring to FIG. 1, an optical medium 10 may be a fiber, a planar waveguide, or a planar light wave circuit, or a free-space material to mention a few examples. A light signal 16 is provided to the optical medium 10 and an output signal 18 exits from the optical medium 10. The optical medium 10 itself or components which pass either the input signal 16 or the output signal 18 may induce dispersion.

The induced dispersion may be compensated for by a tunable dispersion compensator utilizing the photoelastic property of the optical medium 10. In one embodiment, the tunable dispersion compensator may include a material 12 that expands or contracts piezoelectrically in response to an induced voltage 14. In other words, in response to a change in voltage, the material 12 either expands, as indicated by the arrows, or contracts in the opposite direction.

In one embodiment, the optical medium 10 is fixed to the material 12 so that when the material 12 expands, the optical medium 10 expands and vice versa. As a result, the piezoelectric material 12 can induce the stress within the optical medium 10.

In one embodiment, the optical medium 10 includes at least a portion which is photoelastic. Photoelasticity is the property of a material that its index of refraction changes with applied stress. As the light wave signal 16 propagates through the optical medium 10, an appropriately applied stress is applied through the piezoelectric material 12 either in a bulk-optic or guided-wave configuration.

The refractive index of the optical medium 10 can be changed by subjecting it to a force as indicated by the following equation:

$$n ( σ ) = {n}_{0} - \frac{1}{2} {n}_{0}^{3} q σ$$

where n₀ is the refractive index in the absence of a force, q is the elasto-optic constant of the material, and σ is the stress induced in the material due to the applied force. Thus, the stress-induced change in the refractive index is a non-linear function of the stress-free index, which can be utilized to achieve tunable dispersion.

The corrective dispersion induced on the light signal 16 upon propagation through the optical medium 10 can be derived as:

$$D = - \frac{λ L}{c} \frac{{ⅆ}^{2} n}{ⅆ {λ}^{2}} = [ \{ 3 {{n}_{0} ( \frac{ⅆ {n}_{0}}{ⅆ λ} )}^{2} + \frac{3}{2} {n}_{0}^{2} \frac{{ⅆ}^{2} {n}_{0}}{ⅆ {λ}^{2}} \} q σ - \frac{{ⅆ}^{2} {n}_{0}}{ⅆ {λ}^{2}} ] \frac{λ L}{c}$$

where λ is the optical wavelength, L is the propagation length in the medium 10, and c is the light speed in vacuum. The corrective dispersion may be of the same magnitude, but opposite of the polarity of the induced dispersion so as to substantially cancel the induced dispersion.

Thus, referring to FIG. 2, the applied corrective dispersion can be tuned as a function of the stress applied to the medium 10. The applied stress is shown on the horizontal axis, while the induced dispersion is shown on the horizontal axis. In this case, q is −5×10⁻⁸ m²/N, L=10 cm. Thus, the possible dispersion correction in this example may extend from +300 ps/nm to −300 ps/nm. In other embodiments other materials having a different value of the elasto-optic constant (q) and length (L) may be used.

A suitable photoelastic medium may be bonded to the piezoelectric stage so that the required stress can be imparted by an applied voltage. Alternatively, stress can be applied by subjecting the medium to a mechanical force. A device can also be made in a planar integrated format. For example, a silica-on-silicon platform may be used wherein the suitable photoelastic material is deposited in a waveguide form and the stress is applied either piezoelectrically or mechanically.

The dispersion achieved is modulated by simply varying the applied stress to the photoelastic medium. Thus, a less bulky tunable dispersion compensation device may be achieved and, in some embodiments, may be integrated with other optical components within the same package.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
applying stress to an optical medium to provide a desired dispersion compensation.

2. The method of claim 1 including applying stress to an optical medium including a photoelastic medium to generate a corrective dispersion of the opposite polarity of a dispersion induced in the optical medium.

3. The method of claim 2 including using a piezoelectric device to generate stress in an optical medium.

4. The method of claim 3 including controlling the amount of stress and thereby the desired dispersion compensation by controlling the voltage applied to said piezoelectric device.

5. The method of claim 4 including securing the photoelastic medium to said piezoelectric device and passing an optical signal through said photoelastic medium.

6. A method comprising:
securing a photoelastic medium to a piezoelectric device; and
applying a voltage to the piezoelectric device to induce a stress in said photoelastic medium appropriate to correct dispersion generated in an optical system coupled to said photoelastic medium.

7. The method of claim 6 including controlling the voltage applied to said piezoelectric device to generate a dispersion of a polarity opposite to the polarity of a dispersion generated in said optical system.

8. The method of claim 7 including generating a corrective dispersion of substantially the same magnitude as the dispersion generated in said optical system.

9. An optical system comprising:
an optical medium defining an optical path;
a photoelastic material in said optical path; and
a device to controllably stress said photoelastic medium to generate a dispersion of an appropriate polarity and magnitude to correct a dispersion induced in said optical medium.

10. The system of claim 9 wherein said device is a piezoelectric actuator.

11. The system of claim 10 including a voltage source to control the amount of voltage applied to said piezoelectric actuator to enable tuning of the dispersion applied through said photoelastic medium.

12. An optical system comprising:
an optical medium defining an optical path;
a photoelastic material in said optical path; and
a piezoelectric actuator coupled to said photoelastic material.

13. The system of claim 12 wherein said piezoelectric actuator is secured to said photoelastic medium.

14. The system of claim 13 including a voltage source to controllably apply potential to said piezoelectric actuator.

15. The system of claim 14 to provide a tunable magnitude and polarity of dispersion to cancel dispersion generated along said optical path by said optical medium.
